(19) United States
(12) Patent Application Publication
(10) Pub. No.: US 2009/0321370 A1
(43) Pub. Date: Dec. 31, 2009

(54) Apparatus for treating a liquid with a gas

(76) Inventor: William R. Nelson, LaConner, WA (US)

Correspondence Address: Glenn Rickards, 15100 SE 38th St. PMB 780, Bellevue, WA, 98006, US

(21) Appl. No.: 12/310,648

(22) PCT Filed: Sep. 5, 2007
(86) PCT No.: PCT/US07/19335

§ 371 Date: Mar. 4, 2009

Related U.S. Application Data
(60) Provisional application No. 60/843,148, filed on Sep. 6, 2006.

(51) Int. Cl. C02F 1/78; B01F 5/12; B01F 3/04

(52) U.S. Cl. 210/760; 261/36.1; 239/8

(57) ABSTRACT

An ozonation system may include a mixing chamber having an inlet to a recirculation conduit within the chamber and proximate to its top, a recirculation conduit for withdrawing fluid from the mixing chamber through the inlet and conducting it to a pump, a venturi connected to the outfeed of the pump for induction of ozone into the water, an infeed for reintroducing a water-ozone mixture back into the chamber, the infeed terminating in a restricting nozzle.

### BACKGROUND

Treatment of a liquid with a gas, such as, for example, treating of water with ozone, is complicated by the fact that gasses do not always readily dissolve in the liquid. Mass transfer of the gas to the liquid may be enhanced by reducing the size of the bubbles of the gas in the liquid. This may result, in part, from the fact that the surface area of a bubble containing a single unit of gas is lower than is the case if the same volume of gas is contained within multiple bubbles. Of course, one difficulty presented by the presence of bubbles of a gas in a liquid is the tendency of bubbles to coalesce into fewer, larger bubbles. Larger bubbles tend to rise in the fluid and may accumulate at the top of a tank through which the fluid flows.

Addition of ozone to water has been accomplished by using a venturi to entrain ozone-containing oxygen in a stream of water. To avoid accumulation of ozone in the workplace, so that workers are not exposed to the deleterious health effects of high ambient ozone levels, ozone that separates out of the water may be vented to an ozone-destruction unit. Such accumulations of ozone-bearing gas may occur, for example, in ozonation systems that allow the gas to accumulate, for example, at the top of a tank through which the gas-liquid mixture flows.

Ozone may be generated by application of a high voltage electrical field to oxygen or air, such as by corona discharge in oxygen, by exposure to oxygen to ultraviolet light, and by other means known in the art. Although much of the oxygen will remain in its diatomic form, the resulting gas that is enriched in ozone by this or other processes will be generally referred to herein as ozone.

### BRIEF DESCRIPTION OF THE DRAWINGS

FIG. 1 is a cross-sectional view of a liquid-gas mixing system.

FIG. 2 is a rear elevation of a liquid-gas mixing chamber with internal parts shown in phantom.

FIG. 3 is an isometric view of a liquid-gas mixing system showing the gas line, check valve, venturi and pump, with parts broken away.

FIG. 4 is an internal plan view of the rear wall of the liquid-gas mixing chamber.

### DETAILED DESCRIPTION

For simplicity, and although the liquid-gas mixer of the embodiments discussed below may be suitable for mixing gasses and liquids other than ozone and water, the embodiments may be discussed in connection with the mixing of ozone and water. References to ozone will be understood by those skilled in the art to include gasses such as oxygen that are enriched with ozone. Likewise, mixtures of liquids and gasses will be understood to mean both liquids, such as water, in which a gas, such as ozone, has been dissolved, as well as liquids in which gas bubbles are present. As is known in the art, gas bubbles of a sufficiently small size may be easily entrained in the flow of water and other liquids.

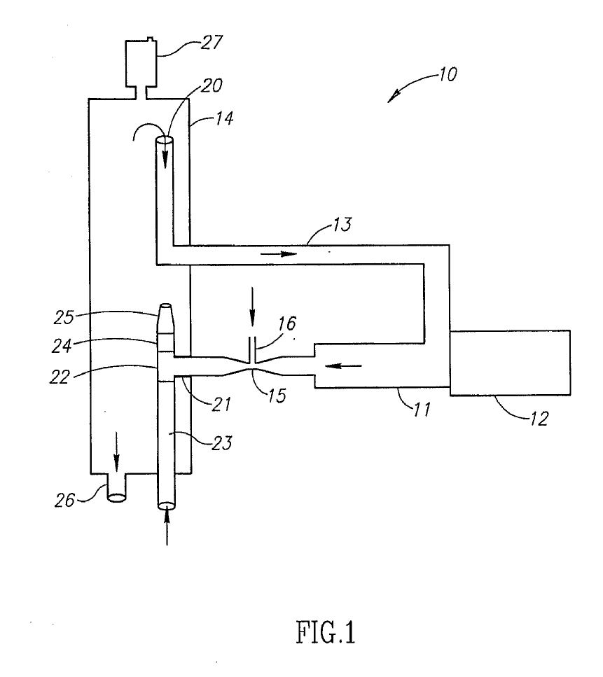

As shown in FIG. 1, a water-ozone mixer system 10 according to embodiments of the present invention may include a number of different components. These may include a pump 11 and motor 12, a recirculation conduit 13 for recirculating water from the mixing chamber 14 through the pump 11, a venturi 15 that receives water from the pump 11 and passes it into the mixing chamber 14. The venturi 15 has a gas inlet tube 16 through which ozone may be introduced into the water flowing through the venture 15. The recirculation conduit 13, pump 11 and venturi comprise a recirculation for recirculating liquid withdrawn from the mixing chamber 14 back into the mixing chamber.

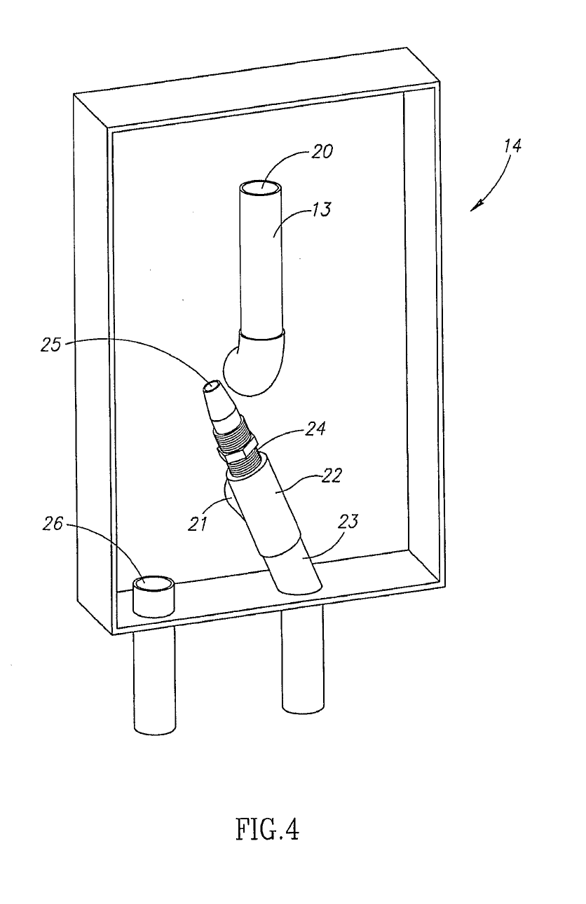

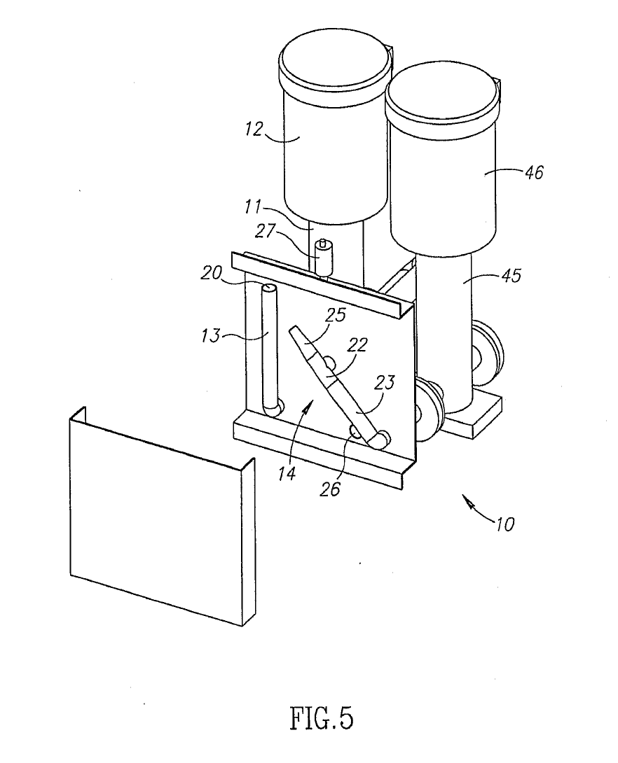

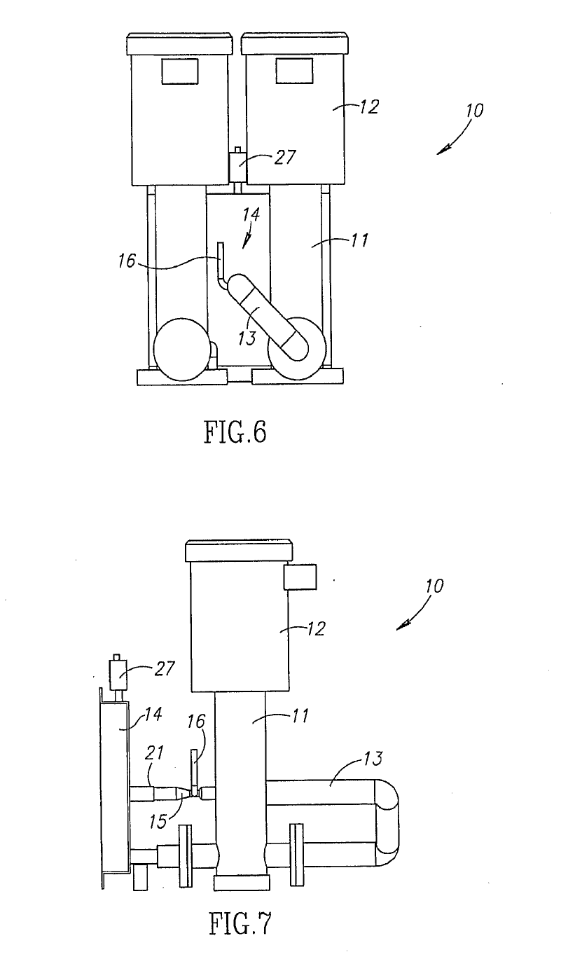

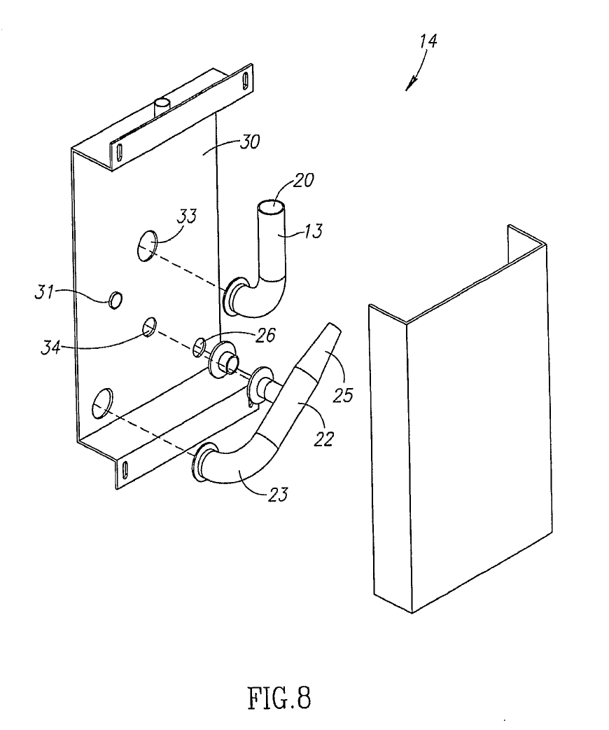

Referring to FIGS. 1, 2 and 4, internally of the mixing chamber 14, in the present embodiment, the recirculation conduit 13 may turn upward within the mixing chamber 14 and may extend to a position proximate the top of the mixing chamber 14, where it terminates in an inlet 20. The venturi 13 is connected to an inlet pipe 21 that extends into the mixing chamber 14 and terminates in a “T” fitting 22. The lower arm of the “T” fitting may be connected to a pipe 23 that may be connected to a water source, such as a municipal water supply. Thus the “T” fitting serves to combine the water flow from the inlet water supply flowing through the conduit 23 with the water flowing through the recirculation conduit 13. This pipe 22 may extend through the bottom wall of the mixing chamber 14. The upwardly-extending arm of the “T” fitting may be connected to a conduit 24 that terminates in a nozzle 25 having an outlet diameter that is less than the internal diameter of the conduit 24. For example, in one embodiment, the recirculation conduit 13, inlet pipe 21, pipe 23 and conduit 24 may all be of one inch (2.45 cm) diameter, and the nozzle may be of ½ inch (1.23 cm) diameter. An outlet 26 may be provided in the bottom wall of the mixing chamber 14 to permit the outflow of ozonated water from the mixing chamber 14. A purge valve 27 may be provided at the top of the mixing chamber 14 to allow for removal of gasses form the mixing chamber 14. Such accumulation of gas in the mixing chamber may result when the pump 11 is turned off and water ceases to be withdrawn from the mixing chamber 14. In such case, the bubbles of the gas will tend to rise in the mixing chamber 14 and coalesce at the top of the chamber 14. Air or other gasses may also be purged from the system when the system is filled, for example, after initial installation or after maintenance involving disconnection of the water supply.

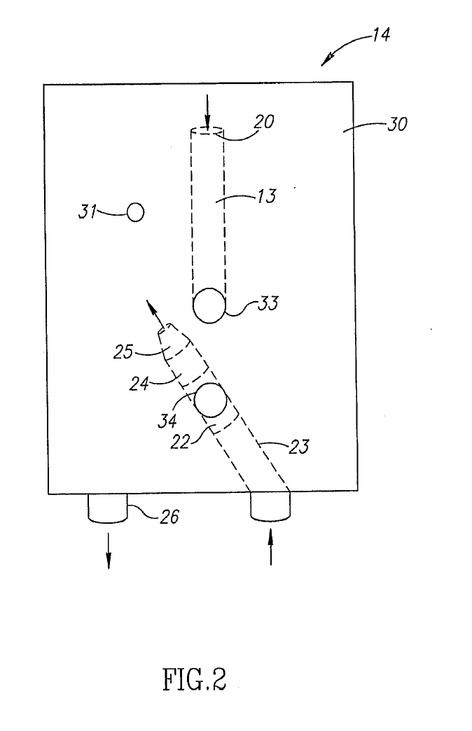

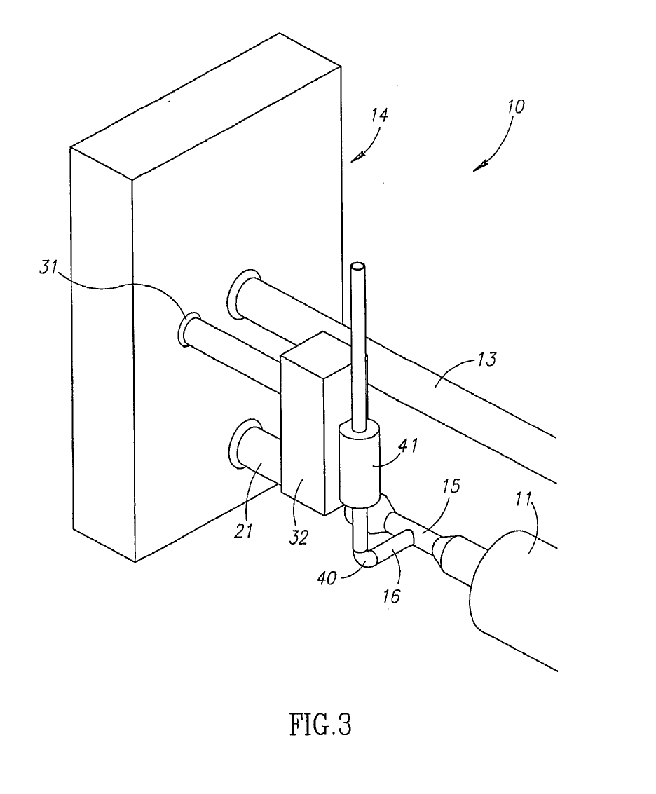

According to an embodiment of the invention, and with reference to FIG. 2, the rear wall 30 of the mixing chamber 14 may include an aperture 31 for a pressure sensor 32 (see FIG. 3) for monitoring, for example, the pressure or temperature within the mixing chamber 14. A sensor 32 mounted in the aperture 31 may be used by a control system to determine when the pump 11 should be turned on and off in response to commencement and cessation of the flow of fluids from the mixing chamber through an outlet 26. An aperture 33 may be provided in the rear wall of the mixing chamber 14 so that the recirculation conduit 13 can extend from the mouth 20 to the pump 11. An inlet aperture 34 may be provided remote from the outlet aperture 33 so that water flowing from the venturi 15 may pass through the rear wall 30 and into the inlet pipe 21 that conducts it to the “T” fitting 22. The outlet aperture 33 may be threaded for engagement with the pipes that form the recirculation conduit 13. Likewise, the inlet aperture 34 in the rear wall 30 may be threaded to facilitate attachment of the inlet pipe 21 and venturi 15 on opposite sides of the rear wall 30 of the mixing chamber.

Referring to FIG. 3, according to one embodiment, the gas inlet 16 of the venturi 15 may be connected through an elbow 40 and check and shutoff valve 41 to an ozone supply tube 42 from an ozone generator (not shown).

A liquid-gas mixing system according to one embodiment may function as follows. Referring to FIGS. 1-4, according to an embodiment, water may be flowed into the mixing chamber 14 through the pipe 23 to fill the mixing chamber 14, recirculation conduit 13, pump 11, venturi 15, etc. The check and shutoff valve 41 restricts the water from flowing into the ozone supply tube 42.

Once the system has been filled with water, and the motor 12 has been turned on, the pump 11 begins circulating water from the mixing chamber 14 through the recirculation conduit 13, the pump 11 and the venturi 15, and back into the mixing chamber 14. In one embodiment, where the piping used in the system is of one inch (2.54 cm) diameter, a two horsepower motor 12 is used to drive a pump 11 that has seven impellers. This arrangement may produce pressures on the order of 160 psi (1.1 megapascals) behind the venturi 15.

When the ozone supply is engaged, ozone travels through the ozone supply tube 42 and through the elbow 40 into the venturi 15. The ozone is entrained in the stream of water exiting the venturi 15 and is conducted through the rear wall 30 of the mixing chamber 14 to the “T” fitting 22, where it may mix with water at, for example, 80 psi (550 kilopascals) water supplied through the pipe 23 that may be connected to a water supply, such as a municipal water supply. Water may flow from the water supply through the pipe 23 as water is withdrawn through the outlet 26.

The mixture of water from the water supply and the water/ozone mixture from the venturi then passes through the conduit 24 and nozzle 25. In the present embodiment, the nozzle as a ½ inch (1.27 cm) orifice. The turbulence and compression of the ozone bubbles in the water as it passes through the nozzle 25 may aid in reducing the size of the bubbles and in the dissolving of ozone in the water. In the present embodiment, the nozzle 25, conduit 24, “T” fitting 22 and pipe 23 extend upward at an angle within the mixing chamber 14. Other orientations are possible.

Larger bubbles tend to rise more quickly in the water in the mixing chamber 14. The inlet 20 of the recirculating conduit 13 is accordingly placed near the top of the tank so that these bubbles in particular are drawn into the recirculation conduit and passed through the pump 11, venturi 15 and other components of the system. The presence of bubbles in general and larger bubbles in particular in the recirculating fluid may diminish the efficiency of the pump 11, in this embodiment, the pump 11 may be provide with a great number of impellers, such as the seven impellers mentioned above, and may be driven by a larger motor 12, such as the aforementioned two horsepower (1.5 kilowatt) motor, than would be used for a similar system recirculating only water. Of course, bubbles passing through the impellers of a pump 11 may be broken up into smaller bubbles, and the passage through the venturi may further reduce the size of bubbles.

Production of micron and submicron bubbles is desirable because the smaller the bubbles are, the greater the ratio of surface area to volume becomes. This permits more rapid and efficient mass transfer of the ozone into the water and aids in achieving a high ozone level in the water.

Placement of the inlet 20 of the recirculating conduit 13 near the top of the mixing chamber 14 may reduce or eliminate any accumulation of ozone at the top of the mixing chamber 14. In instances where such accumulation occurs, of course, it can be removed through the purge valve 27.

The nozzle 25 and venturi 15 may be of the type provided by the Mazzei Injector Corporation of Bakersfield, Calif., model number 1078 and 14, respectively. Other suitable venturis 15 and nozzles 25 may be used, and nozzles may even be fashioned from piping or nipple fittings for piping in which the end is crosscut in the shape of an “X” to a sufficient depth and width that, when the free ends are bent in toward one another and welded or otherwise joined together, an orifice of suitable size is produced.

The ozone/water mixture in the mixing chamber 14 is, of course, under pressure as a result of the pressure from the water supply applied through the pipe 23. When water is allowed to flow through the outlet 26, it thus flows under pressure and may entrain bubbles of ozone therein. The smaller bubbles, in particular, submicron bubbles, may be more likely to be entrained in this flow out of the outlet 26 in the bottom of the mixing chamber 14 as they tend to rise more slowly.

As shown and discussed above, an embodiment may use a relatively small mixing chamber in conjunction with a high level of recirculation of the ozone and water through the pump 11 and nozzle 25, and may achieve a high level of ozonation. It is believed that various embodiments may produce micron and submicron bubbles in significant quantities.

Referring to FIGS. 5-7, the pressure of the water supply may not always be as high as may be desired for purposes of practicing of the invention. For example, if the pump 11 and motor 12 of a system 10 are sized and designed to produce a pressure of 80 psi at the outlet of the venturi 15, an inlet pressure of 80 psi from the water supply may be desired. Accordingly, a booster pump 45 of sufficient size and efficiency, and driven by a suitable motor 46 may be used to supply water to the mixing chamber 14 at a desired pressure. In FIGS. 5-7, the pumps 11, 45 and motors 12, 45 are arranged vertically and positioned proximate to the mixing chamber 14. This may allow the system to be more compact.

As with the embodiments of FIGS. 1-4, the water mixing system comprising the the “T” fitting 22 and the nozzle 25 may be inclined from the vertical, and the incline and positioning of these elements may be helpful in controlling the circulation of water or other liquid within the mixing chamber 14. For example, the water mixing system may be inclined at 52 degrees from vertical.

While the positioning of the outlet 26 for the gas/liquid mix may be varied, it may be positioned at the bottom or lower side, front or back wall to reduce the likelihood that the larger bubbles will be withdrawn from the chamber 14 therethrough.

The ratio of fluid withdrawn from the mixing chamber to fluid recirculated through the recirculation system (comprising the conduit 13, pump 11, venturi 15, inlet pipe 21 and the like members as shown in the embodiments depicted in FIGS. 1-8) may be varied to affect the degree of mixing achieved.

Although the present invention has been described in considerable detail with reference to certain embodiments, other embodiments are possible. Therefore, the spirit or scope of the appended claims should not be limited to the description of the embodiments contained herein.

I claim:

1. A method of mixing a liquid with a gas comprising the steps of:
recirculating a portion of the liquid from the mixing chamber through a pump;
adding a gas to the recirculated portion of liquid from the chamber;
combining the recirculated portion of liquid with a supply liquid;
introducing the combined recirculated liquid and supply liquid into the mixing chamber; and
withdrawing liquid from the mixing chamber.

2. The method of claim 1 wherein the combining of the recirculated portion of liquid with a supply liquid occurs in a conduit having two inlets with the supply liquid being introduced to one inlet of the conduit and the recirculated liquid being supplied to another inlet of the fitting.

3. The method of claim 1 wherein the gas is added to the liquid via a venturi prior to mixing the recirculated portion of liquid with the supply liquid.

4. The method of claim 1 wherein the recirculated liquid is withdrawn from the mixing chamber through an outlet proximate to the top of the mixing chamber.

5. The method of claim 4 wherein the liquid withdrawn from the mixing chamber is withdrawn through an outlet proximate to the bottom of the mixing chamber.

6. The method of claim 1 wherein the combined recirculated liquid and supply liquid are introduced into the mixing chamber through a restricted orifice.

7. The method of claim 6 wherein the restricted orifice comprises a nozzle.

8. The method of claim 1 wherein the combined recirculated liquid and supply liquid are introduced into the mixing chamber in a non-vertical flow direction.

10. The method of claim 1 wherein the supply liquid is pressurized by a pump prior to its introduction into the mixing chamber.

11. The method of claim 2 wherein the conduit having two inlets constitutes a “T” fitting.

12. The method of claim 1 wherein the liquid is water and wherein the gas contains ozone.

13. A system for mixing a liquid with a gas comprising:
a mixing chamber having an inlet for receiving a supply liquid and an outlet for outflow of a liquid-gas mixture;
a recirculation system comprising a recirculation outlet for withdrawing liquid from the mixing chamber and a recirculation inlet for reintroducing the liquid into the mixing chamber;
a pump for circulating liquid through the recirculation system from the outlet to the inlet;
an injector for introducing a gas into liquid flowing into the mixing chamber.

14. The system of claim 13 wherein the injector comprises a venturi in the recirculation system, the venturi having a liquid inlet and outlet and a gas inlet

15. The system of claim 13 further comprising a conduit having two inlets for combining liquid flowing through the inlet of the mixing chamber with liquid flowing through the recirculation inlet.

16. The system of claim 15 wherein the recirculation outlet is positioned within the mixing chamber proximate to the top thereof whereby gas bubbles proximate to the top of the mixing chamber may be drawn into the recirculation system.

17. The system of claim 15 wherein the conduit is mounted internally to the mixing chamber and where the conduit further comprises an outlet having a restricted orifice.

18. The system of claim 17 wherein the orifice directs the liquid flowing therethrough into the mixing chamber at a non-vertical angle.

19. An ozonation system comprising:
a mixing chamber having an inlet and an outlet, and further having a recirculation inlet proximate to the top of the mixing chamber and a recirculation outlet;
a recirculation system comprising a conduit connecting the recirculation inlet and outlet, a pump for circulating water from the recirculation inlet to the recirculation outlet, the conduit further comprising a venturi having an ozone inlet for introducing ozone into water flowing through the venturi;
a combiner having at least two inlets and at least one outlet, one inlet being connected to the water inlet of the mixing chamber and the other inlet being connected to the recirculation system for receiving a mixture of water and ozone therefrom, the conduit having an outlet terminating in a nozzle mounted in the mixing chamber.
